(19) United States
(12) Patent Application Publication
(10) Pub. No.: US 2025/0371094 A1
(43) Pub. Date: Dec. 4, 2025

(54) Generation and Processing of Entry Variants

(71) Applicant: Contentstack Inc., San Francisco, CA (US)

(72) Inventors: Christopher Ryan Jennings, Nashua, NH (US); Suvish Varghese Thoovamalayil, Virar West (IN); Amey Santosh Khale, Virar West (IN)

(21) Appl. No.: 19/042,548

(22) Filed: Jan. 31, 2025

(30) Foreign Application Priority Data
Jun. 1, 2024 (IN) 202411042723

(51) Int. Cl. G06F 16/957; G06F 16/958

(52) U.S. Cl. CPC G06F 16/9577; G06F 16/958

(57) ABSTRACT

Methods, systems, devices, and non-transitory computer readable media for processing content are provided. The disclosed technology can include receiving entries comprising base entries and entry variants. Variant portions of the content comprising portions of content that are included in the entry variants and portions of content that are not included in base entries can be determined. The base entries and variant portions of the content can be stored. An application programming interface (API) request comprising attributes associated with a selected entry of the entries can be received. Based on the attributes, the base entry and variant portions of the content that are associated with the selected entry and implemented on the client computing device can be determined. Furthermore, the base entry and the variant portions of the content that are associated with the selected entry and implemented on the client computing device can be sent to the client computing device.

### RELATED APPLICATION

The present application is based on and claims priority to Indian Provisional Patent Application No. 20/241,1042723, filed on Jun. 1, 2024, which is incorporated by reference herein in its entirety.

### FIELD

The present disclosure relates generally to generating and processing entry variants. More particularly, the present disclosure relates to generating, processing, and storing entry variants associated with web resources.

### BACKGROUND

Content can be generated and distributed to a variety of computing devices via networks. Due to the large volume of content that can be transmitted and stored, various techniques and rules can be used to manage the content. However, the use of some of these techniques and rules can result in a significant expenditure of resources including computational and storage resources. To address the potential challenges associated with processing content various types of software can be used to send, process, and receive the content. Depending on the circumstances, generic software applications may not be properly suited to handling such tasks. As such, there are many different approaches that can be used in the processing of content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of processing entry variants. The computer-implemented method can comprise receiving, by a computing system comprising one or more processors, a plurality of entries comprising a plurality of base entries and one or more entry variants that are variants of the plurality of base entries. The plurality of entries can comprise a plurality of portions of content associated with one or more web resources. The computer-implemented method can comprise determining, by the computing system, one or more variant portions of the content comprising the plurality of portions of the content that are included in the one or more entry variants and the plurality of portions of the content that are not included in the plurality of base entries. The computer-implemented method can comprise storing, by the computing system, the plurality of base entries and the one or more variant portions of the content. The computer-implemented method can comprise receiving, by the computing system, an application programming interface (API) request associated with a selected entry of the plurality of entries. The API request can comprise one or more attributes associated with representation of the selected entry. Further, the one or more attributes can comprise information associated with the content that is implemented on a client computing device associated with the API request. The computer-implemented method can comprise determining, by the computing system, based on the one or more attributes, the base entry and the one or more variant portions of the content that are associated with the selected entry and implemented on the client computing device. The computer-implemented method can comprise sending, by the computing system, to the client computing device, the base entry and the one or more variant portions of the content that are associated with the selected entry and not implemented on the client computing device.

Another example aspect of the present disclosure is directed to one or more tangible non-transitory computer-readable media storing computer-readable instructions that when executed by one or more processors cause the one or more processors to perform operations. The operations can comprise receiving a plurality of entries comprising a plurality of base entries and one or more entry variants that are variants of the plurality of base entries. The plurality of entries can comprise a plurality of portions of content associated with one or more web resources. The operations can comprise determining one or more variant portions of the content comprising the plurality of portions of the content that are included in the one or more entry variants and the plurality of portions of the content that are not included in the plurality of base entries. The operations can comprise storing the plurality of base entries and the one or more variant portions of the content. The operations can comprise receiving an application programming interface (API) request associated with a selected entry of the plurality of entries. The API request can comprise one or more attributes associated with representation of the selected entry. Further, the one or more attributes can comprise information associated with the content that is implemented on a client computing device associated with the API request. The operations can comprise determining, based on the one or more attributes, the base entry and the one or more variant portions of the content that are associated with the selected entry and implemented on the client computing device. The operations can comprise sending, to the client computing device, the base entry and the one or more variant portions of the content that are associated with the selected entry and not implemented on the client computing device.

Another example aspect of the present disclosure is directed to a computing system comprising: one or more processors; one or more non-transitory computer-readable media storing instructions that when executed by the one or more processors cause the one or more processors to perform operations. The operations can comprise receiving a plurality of entries comprising a plurality of base entries and one or more entry variants that are variants of the plurality of base entries. The plurality of entries can comprise a plurality of portions of content associated with one or more web resources. The operations can comprise determining one or more variant portions of the content comprising the plurality of portions of the content that are included in the one or more entry variants and the plurality of portions of the content that are not included in the plurality of base entries. The operations can comprise storing the plurality of base entries and the one or more variant portions of the content. The operations can comprise receiving an application programming interface (API) request associated with a selected entry of the plurality of entries. The API request can comprise one or more attributes associated with representation of the selected entry. Further, the one or more attributes can comprise information associated with the content that is implemented on a client computing device associated with the API request. The operations can comprise determining, based on the one or more attributes, the base entry and the one or more variant portions of the content that are associated with the selected entry and implemented on the client computing device. The operations can comprise sending, to the client computing device, the base entry and the one or more variant portions of the content that are associated with the selected entry and not implemented on the client computing device.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system content management entry variants according to example embodiments of the present disclosure.

FIG. 2 depicts a block diagram of an example system for content management entry variants according to example embodiments of the present disclosure.

FIG. 3 depicts a block diagram of an example of the resolution of entries comprising base entries and variant entries according to example embodiments of the present disclosure.

FIGS. 4A-4D depict examples of entry variants of content that are displayed via a user interface of a client device according to example embodiments of the present disclosure.

FIG. 5 depicts a block diagram of an example system for content management systems entry variants according to example embodiments of the present disclosure.

FIG. 6 depicts a flow chart diagram of an example method of processing content according to example embodiments of the present disclosure.

FIG. 7 depicts a flow chart diagram of an example method of processing content according to example embodiments of the present disclosure.

FIG. 8 depicts a flow chart diagram of an example method of processing content according to example embodiments of the present disclosure.

FIG. 9 depicts a flow chart diagram of an example method of processing content according to example embodiments of the present disclosure.

### DETAILED DESCRIPTION

The present disclosure is directed to processing entry variants associated with content. In particular, the disclosed technology can be used to generate and process entries that include content used in web resources (e.g., a webpage that displays content comprising images and text). Processing the entries can include distinguishing the content that is included in base entries from the variant content included in entry variants. Further, processing the entries can include deduplicating the variant portions of the content, which can improve the efficiency with which storage resources are utilized. Based on API requests from client computing devices that request content, the portions of content that are different from the content implemented on the client computing devices can be determined and sent to the client computing devices.

Additionally, the entry variants of the disclosed technology can be used to generate alternate versions of content entries for a variety of tasks including A/B testing, content personalization, and/or other tasks in which different variants of content are provided in accordance with different task requirements. Using the disclosed technology, content redundancy can be reduced by selectively storing base entries and variant portions of content. Additionally, the disclosed technology allows for more effective processing and transmission of entries by automatically resolving conflicts that arise when entry variants are requested.

The disclosed technology can include a computing system that is configured to receive one or more entries that include base entries and entry variants that are variants of the base entries. For example, a computing system can receive entries via a local network and/or the Internet. The entries can comprise a plurality of portions of content associated with one or more web resources. For example, the entry variants can comprise variants of web pages that include different combinations and/or arrangements of content including images and/or text. The computing system can determine one or more variant portions of the content comprising the plurality of portions of the content that are included in the one or more entry variants and the plurality of portions of the content that are not included in the plurality of base entries. For example, the computing system can perform comparison operations to identify the variant portions of the content and distinguish the portions of the content that are included in the base entries from the variant portions of content.

The computing system can then store the plurality of base entries and the one or more variant portions of the content. For example, the computing system can store the base entries and variant portions of the content in one or more cloud storage devices. The computing system can receive an application programming interface (API) request associated with a selected entry of the plurality of entries. The API request can comprise attributes associated with representation of the selected entry. For example, the computing system can receive an API request from a client computing device (e.g., a laptop computing device). The API request can include attributes associated with the language that is used in a web page (e.g., an ecommerce web page). Further, the API request can indicate the content (e.g., web content implemented on a browser that is executed on the client computing device) that is being implemented on a client computing device associated with the API request.

The computing system can, based on the one or more attributes, determine the base entry and the one or more variant portions of the content that are associated with the selected entry and implemented on the client computing device. For example, the computing system can search a database comprising the entries and determine the entry that matches or is similar to the selected entry. The computing system can then send the base entry and the one or more variant portions of the content associated with the selected entry to a client computing device associated with the API request. For example, the computing system that stores the entries can send the requested entry variant and the variant portions of the content associated with the selected entry to a client computing device via the Internet.

In some embodiments, the disclosed technology can comprise a computing system (e.g., an entry variant computing system) that can comprise one or more computing devices (e.g., devices with one or more computer processors and a memory that can store one or more instructions) that can send, receive, process, generate, and/or modify data (e.g., data comprising a plurality of entries that comprise base entries and entry variants). The data and/or one or more signals can be communicated (e.g., sent and/or received) with other computing systems and/or devices (e.g., one or more remote computing systems, one or more remote computing devices, and/or one or more software applications operating on one or more computing devices) that can send and/or receive data including API requests associated with entries. In some embodiments, the computing system (e.g., the entry variant computing system) can comprise one or more features of the user device 110A, the user device 120A, the user device 130A, and/or the network computing system 135 that are described herein.

In some embodiments, the computing system can comprise specialized hardware (e.g., an application specific integrated circuit) and/or software that enables the computing system to perform one or more operations specific to the disclosed technology including receiving entries comprising base entries and entry variants, determining variant portions of content, storing the base entries and variant portions of content, receiving an API request associated with a selected entry, determining the base entry and variant portions of content associated with the selected entry, and/or sending the base entry and entry variant to a client computing device associated with the API request.

The computing system can receive a plurality of entries. The plurality of entries can be associated with content that can be associated with one or more web resources (e.g., webpages). For example, the plurality of entries can comprise the content (e.g., images and/or text) of a plurality of websites. Further, the plurality of entries can comprise information indicating the way in which the content is represented (e.g., content represented on a web page). Further, the plurality of entries can comprise a plurality of base entries and/or one or more entry variants that are variants of the plurality of base entries. The plurality of base entries can comprise content that every variant of an entry includes. For example, a base entry can comprise an image of a title banner that is positioned at the top of an entry (e.g., an entry associated with a webpage) and is the same across different entry variants of the base entry. The different entry variants can comprise different image content and text content that can be associated with different products that are associated with the base entry.

The plurality of entries can comprise a plurality of portions of content. The plurality of portions of content can be associated with one or more web resources. For example, the plurality of portions of content can comprise images and/or text associated with a website. In some embodiments, the plurality of portions of content can comprise one or more images (e.g., photographs, symbols, icons, and/or user interface elements), one or more text segments (e.g., text describing people, places, events, instructions, and/or things), one or more video segments, and/or one or more audio segments. For example, the plurality of portions of content can comprise images that are displayed in a webpage (e.g., a title banner image, one or more images of products for an ecommerce website, and/or one or more images of sporting events for a sports news website). By way of further example, the plurality of portions of content can comprise text segments (e.g., alphanumeric text segments) and/or emojis that can indicate information associated with the content (e.g., text that describes products of an ecommerce website, sports scores associated with sporting events, or news from a news website). Further, the plurality of portions of content can comprise audio segments which can include music, audio notifications, and/or advertisements that can be associated with certain entries of the plurality of entries. In some embodiments, the plurality of portions of content can comprise one or more video segments that can include video that can play automatically and/or be controlled through interactions with a user interface.

In some embodiments, the plurality of entries can comprise a plurality of different combinations of the plurality of portions of the content. In some embodiments, the plurality of entries can be mutually exclusive with respect to other entries of the plurality of entries. comprise entries associated with mutually exclusive.

The computing system can determine one or more variant portions of the content. The one or more variant portions of the content can comprise the plurality of portions of the content that are included in the one or more entry variants and the plurality of portions of the content that are not included in the plurality of base entries. For example, for each base entry of the plurality of base entries, the computing system can determine the associated variant portions of the content. For example, an entry including a webpage associated with an online shopping website can comprise a base variant that includes information associated with a sweater and a plurality of variants in which the image of the sweater is associated with different content comprising images of the sweater in different colors (e.g., content comprising images of a red sweater, a blue sweater, a white sweater, and a black sweater).

The computing system can store the plurality of entries which can comprise the plurality of base entries and/or the one or more variant portions of the content. For example, the computing system can comprise one or more storage devices that can be used to store the plurality of entries comprising the plurality of base entries and/or the one or more variant portions of the content. In some embodiments, the computing system can generate an index based on the plurality of entries. The index can be used to search and retrieve the plurality of entries. Further, the computing system can encrypt the plurality of entries.

The computing system can receive an application programming interface (API) request associated with a selected entry of the plurality of entries. The API request can comprise one or more attributes associated with representation of the selected entry. Further, the API request can be associated with a client computing device. For example, the computing system can receive an API request from a client computing device that receives one or more inputs to a user interface that is used to select a selected entry, generate an API associated with the selected entry, and send, via the Internet or a local area network, the API request to the computing system, selecting a selected entry. Further, the one or more attributes can comprise information associated with the content that is implemented on a client computing device associated with the API request. For example, the one or more attributes can indicate the content (e.g., images, video, audio, and/or text) that is being displayed in a web browser that is implemented on the client computing device.

In some embodiments, the one or more attributes can comprise a language attribute associated with a language of the selected entry, a location attribute associated with a geographic location associated with the client computing device, an operating system attribute associated with an operating system implemented on the client computing device, a referrer attribute associated with a referrer associated with the API request, a device type attribute associated with a device type of the client computing device, a date attribute associated with a date associated with the API request, or a time attribute associated with a time of day associated with the API request.

The computing system can determine the base entry and/or the one or more variant portions of the content that are associated with the selected entry and/or implemented on the client computing device. Further, determination of the base entry and the one or more variant portions of the content can be based on the one or more attributes, the base entry and/or the one or more variant portions of the content associated with the selected entry. For example, if the selected entry is associated with a base entry the computing system can search a database (e.g., a database comprising the plurality of entries comprising the plurality of base entries and/or the one or more variant portions of the content) for a base entry associated with the one or more attributes in the API request. By way of further example, if the selected entry is associated with a base entry and one or more variant portions the computing system can search a database for a base entry and one or more variant portions of content associated with the one or more attributes in the API request. Further, the computing system can determine, based on the state of the content implemented on the client computing device, the one or more variant portions of the content that are implemented on the client computing device. For example, the computing system can determine the web content that is being displayed and/or generated on a client computing device that implements a web browser.

The plurality of entries can comprise information associated with the one or more attributes and indicate the type of content that are associated with an entry. For example, an entry associated with a webpage for a product (e.g., an automobile) of an ecommerce website can comprise information indicating that the attributes of the website are associated with a particular product. The computing system can then search the pluralities of entries for the base entry and/or the one or more variant portions of the content that is similar to and/or matches the attributes associated with the API request. In some embodiments, the computing system can search an index that is associated with the plurality of entries.

The computing system can send the base entry and/or the one or more variant portions of the content associated with the selected entry to a client computing device associated with the API request. Further, the computing system can send, to the client computing device, the base entry and the one or more variant portions of the content that are associated with the selected entry and not implemented on the client computing device. For example, the computing system can send, to the client computing device, the content that is requested in the API that is different from the content that is already being implemented and/or displayed in a web browser of the client computing device. By way of further example, the computing system can send the base entry and/or the one or more variant portions of the content to a client computing device comprising a laptop computing device. The base entry and/or the one or more variant portions of the content can be sent via a local area network, a wide area network, and/or the Internet.

The computing system can generate a web resource based on the selected entry. The web resource can comprise a web page configured to display the base entry and the one or more variant portions of content associated with the selected entry. For example, based on a selected entry associated with content associated with attributes (e.g., attributes based on an IP address associated with the API request) indicating a location, a webpage using the language associated with the attributes language indicating the location comprising a webpage for a home page of a law firm.

In some embodiments, the API request can be based on one or more inputs to a user interface implemented on the client computing device. The user interface can comprise a plurality of interface elements that are associated with selection of the one or more attributes. Further, the client computing device can implement a web browser that is configured to receive inputs to select interface elements associated with the one or more attributes. For example, a client computing device (e.g., a laptop computing device or smartphone) can implement a web browser that generates a user interface comprising interface elements (e.g., drop down menus, clickable buttons, and/or radio buttons). Based on detection of the one or more inputs to the user interface, the client computing device can generate the API request which can comprise one or more attributes associated with the one or more inputs. For example, if the interface element is associated with modifying the language of an entry, the client computing device can generate an API request comprising one or more attributes associated with an entry that comprises content in the language indicated by the interface element.

In some embodiments, the one or more inputs can comprise an input to generate, via a user interface, the one or more attributes based on selection of one or more attribute parameters associated with the representation of the selected entry. For example, the client computing system can generate a graphical user interface that can receive one or more inputs (e.g., touch inputs and/or inputs from an input device comprising a mouse, keyboard, touchpad, and/or stylus). Further, the client computing device can generate interface elements associated with the attributes (e.g., a pulldown list that includes attributes associated with different shipping speeds for a product sold on an ecommerce website). Based on detection of an attribute parameter (e.g., two-day shipping speed), the one or more attributes included in the API request can be associated with the attribute parameter.

In some embodiments, the one or more variant portions of the content can be associated with a plurality of rankings ranging from a lowest ranking to a highest ranking Further, determining the base entry and/or the one or more variant portions of the content associated with the selected entry can comprise determining whether the one or more attributes are associated with more than one variant portion of the one or more variant portions of the content. Further, determining the base entry and/or the one or more variant portions of the content associated with the selected entry can comprise, based on the one or more attributes being associated with more than one variant portion of the content, determining that the selected entry is associated with the variant portion of the content that has the highest ranking. For example, based on an API request that comprises attributes associated with multiple variant portions, the computing system can select the variant portion with the higher ranking.

The computing system can receive, from the client computing device, one or more inputs to generate a customized attribute. Further, the computing system can generate the customized attribute based on the one or more inputs. For example, a client computing device can implement a web browser that generates a user interface comprising interface elements associated with selection of attributes and/or generation of a customized attribute. Based on detection of the one or more inputs to the user interface, the client computing device can generate the customized attribute which can be based on one or more attribute parameters associated with the one or more inputs. The computing system can add the customized attribute to the one or more attributes. For example, the computing system can store the customized attribute in a database comprising the one or more attributes.

The computing system can deduplicate the one or more variant portions of the content. For example, the computing system can deduplicate the one or more variant portions of the content based on the performance of one or more deduplication operations in which duplicate portions of content associated with the one or more entry variants are detected (e.g., detected based on comparison to other entry variants of the one or more entry variants) and tagged as duplicates, not stored with the one or more variant portions of the content, and/or removed.

In some embodiments, the one or more web resources can comprise one or more webpages and/or one or more web applications. For example, the one or more web resources can comprise ecommerce webpages, educational webpages, sports webpages, and/or news webpages.

In some embodiments, the plurality of entries and/or the one or more attributes can comprise information (e.g., layout data) associated with a plurality of layouts of the plurality of portions of the content, a plurality of color schemes of the plurality of portions of the content, and/or one or more sizes of the plurality of portions of the content. For example, layout data associated with the plurality of entries can indicate that an entry has a color scheme that has bright primary colors. By way of further example, size data can indicate the relative size of content so that the content can be modified based on the display associated with the client computing device.

In some embodiments, the plurality of layouts can indicate an arrangement of the plurality of portions of the content in a web resource of the one or more web resources. Further, the plurality of layouts can indicate absolute and/or relative positions of content in a web resource. For example, the plurality of layouts can indicate whether content (e.g., an image or text segment) is at the top, middle, or bottom of a webpage. Further, the plurality of layouts can indicate the content that is positioned next to other content (e.g., content that is positioned above, below, to the left side, or right side of other content). For example, the plurality of layouts can indicate that a text segment indicating the price and name of a product is positioned below an image of the product. In some embodiments, the plurality of layouts can indicate a location of a portion of content based on the type of device that is used to display the content. For example, the layout of content that is displayed on a smartphone can be different from the layout of content that is displayed on a laptop computing device.

In some embodiments, the client computing device can be configured to display a webpage based on the selected entry. For example, the client computing device (e.g., a laptop computing device or a smartphone) can generate a webpage (e.g., a webpage generated in a web browser application implemented on the client computing device) and display the webpage based on the selected entry (e.g., the entry indicated in an API request) in a display component of the client computing device.

The systems, methods, devices, apparatuses, and tangible non-transitory computer-readable media in the disclosed technology can provide a variety of technical effects and benefits that can improve the performance of computing systems. In particular, the disclosed technology can improve the effectiveness with which API calls are generated and processed by being able to reduce the number of API calls that are used to request content updates. As a result of the reduction in API calls, network bandwidth and processing resources can be conserved. Further, API requests of the disclosed technology can consolidate multiple requests into fewer API requests (e.g., a single API request) that can be processed at the API level.

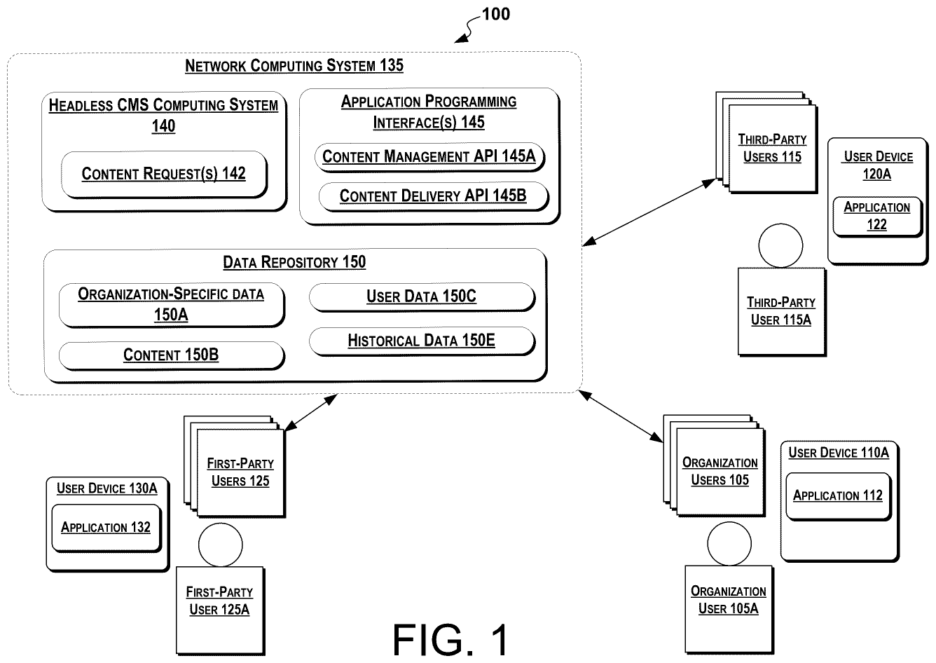

With reference now to the Figures, example embodiments of the present disclosure will be discussed in further detail. FIG. 1 depicts a block diagram of an example system 100 for content management system entry variant storage and resolution according to example embodiments of the present disclosure. As illustrated, FIG. 1 shows a computing system 100 that can include one or more organization users 105 (e.g., organization user 105A), one or more third-party users 115 (e.g., third-party user 115A), and one or more first-party users 125 (e.g., first-party user 125A).

Organization users 105 (e.g., organization user 105A) can be associated with one or more user devices (e.g., user device 110A). User device 110A can be any user device. For instance, user device 110A can be a computer, mobile device, tablet, or other devices. The user device 110A can include a software application 112 associated with a content management service entity, which can run on the user device 110A. As described herein software application can include an application capable of accessing websites or web applications.

The computing system 100 can include one or more third-party users 115. The third-party users 115 can receive data indicative of content from organization users 105. For example, the third-party user 115A can submit a request through a user device 120A associated with the user (e.g., via a software application such as application 122).

The computing system 100 can include one or more first-party users 125. First-party users 125 can include first-party user 125A. First-party users 125 can be associated with one or more devices. For instance, first-party user 125A can be associated with user device 130A. The user device 130A can include an application 132 (e.g., a software application). First-party users 125 can be associated with a headless content management system (headless CMS) service entity (e.g., associated with headless CMS computing system 140). First-party users 125 can include, for example, system engineers, product liaisons, business users, product managers, or administrators associated with the headless CMS service entity.

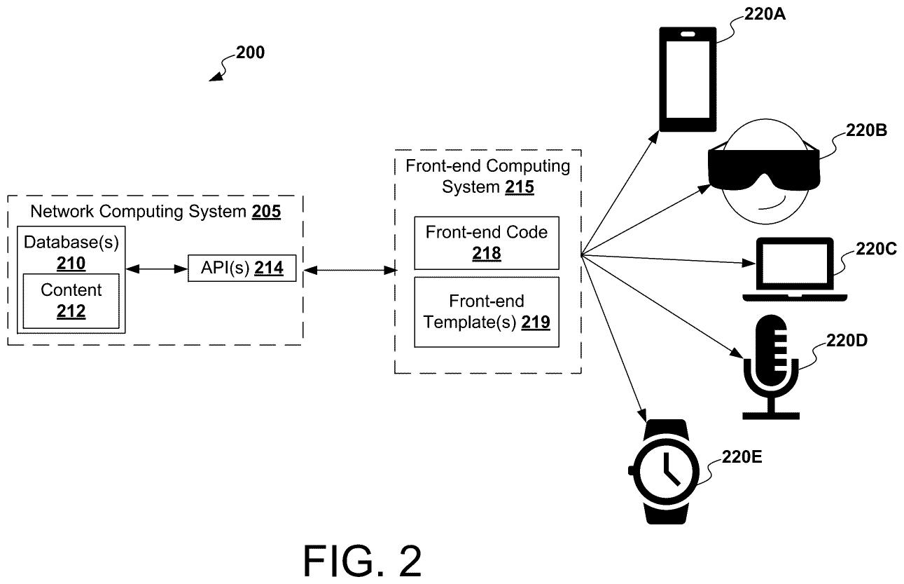

A headless content management system (headless CMS) can include a content management system configured to manage and organize content without a connected front-end or display later. For instance, a headless CMS can provide a platform to allow for creation, editing, and delivery of content to a plurality of front-end device interfaces. The headless CMS can allow for organization users 105 to generate or manage content item that can be stored in backend servers (e.g., associated with network computing system 135) and provided for display to one or more third-party users 115 (e.g., third-party user 115A) via an interface of an associated user device (e.g., user device 120A). An example configuration for a headless CMS is described with regard to FIG. 2. In some implementations, content can include content associated with headless CMS computing system 140 (e.g., content associated with a parent window) or content associated with organization users 105 (e.g., content associated with an entry variant).

A headless CMS can provide benefits including omnichannel content delivery, rapid content deployment (via API), modular content and assets, and limitless integrations that power next-level digital experiences. The benefits can additionally include supporting an unlimited number of digital channels compared to traditional CMS that require multiple parallel content management system instances to provide content to more than one digital channel (e.g., web and mobile). The API approach can facilitate the rapid scaling and/or deployment of new or updated content channels. The content can be managed and deployed across touchpoints without being duplicated or reformatted due to the modular nature of the content (e.g., not being dependent on any specific front-end display). Additionally, the content can connect to a plurality of services and software removing prior silos from systems like CRM, Artificial Intelligence/Machine Learning (AI/ML), personalization tools, or localization platforms.

A network computing system 135 can include a computing system associated with a service entity that can facilitate headless content management between organization users 105 and third-party users 115. Network computing system 135 can include headless CMS computing system 140, application programming interfaces 145, and data repository 150.

A headless CMS computing system 140 associated with the headless CMS service entity can facilitate the delivery of content from organization users 105 to third-party users 115 via associated user devices (e.g., user device 120A). The headless CMS computing system 140 can obtain data indicative of one or more feature utilization requests from organization users 105. The headless CMS computing system 140 can obtain data indicative of one or more content requests 142 from third-party users 115.

Headless CMS computing system 140 can interface with the one or more user devices (e.g., user device 110A, 120A, or 130A) associated with one or more users (e.g., organization users 105, third-party users 115, or first-party users 125) using one or more application programming interfaces 145. For instance, first-party user devices (e.g., user device 130A) can interface with headless CMS computing system 140 via application 132. For instance, organization user devices (e.g., user device 110A) can interface with headless CMS computing system 140 via content management API 145A. For instance, third-party user devices (e.g., user device 120A) can interface with headless CMS computing system 140 via content delivery API 145B.

First-party user 125 (e.g., first-party user 125A) can interact with headless CMS computing system 140 by providing input via an application 132 via user device 130A. For instance, first-party user 125A input can be used to update data repository 150.

Data repository 150 can include organization-specific data 150A, content 150B, user data 150C, historical data 150D, or any other relevant data (e.g., system-level data associated with a plurality of users, expected demand for particular features, expected demand for particular content, and the like). Organization-specific data 150A can include data indicative of user permissions of one or more users associated with a respective organization. For instance, user permissions can include features that are available to the user based on a designated role of the user. User roles can include owner, admin, developer, content manager, or custom role.

Content 150B can include one or more content items obtained from organization users 105. For instance, the organization user 105A can provide a plurality of content items (e.g., assets, images, documents, and the like) to the headless CMS computing system 140 via content management API 145A. The headless CMS computing system 140 can be used to design content that will be displayed to third-party users 115 from the organization users 105.

User data 150C can include data associated with first-party users 125, organization users 105, or third-party users 115. Historical data 150D can include data associated with organization users 105.

The network computing system 135 can include a plurality of potential system architecture designs. FIG. 2 depicts an example system architecture 200 associated with a headless CMS system for facilitating content management and delivery between organization users and third-party users. The architecture can include network computing system 205, front-end computing system 215, and one or more devices 220A-220E.

Network computing system 205 can include database(s) 210 which can include content 212. Content 212 can be content generated or provided by an organization (e.g., organization associated with organization users 105) and stored in database(s) 210. For instance, content can include media files, fields, structures, images, text, video, audio, iFrames, modals, and the like.

Network computing system 205 can include API(s) 214. API(s) 214 can interface with external computing systems. External computing systems can include front-end computing system 215. Front-end computing system 215 can be a web server or some means for interfacing with the one or more devices 220A-220E. Front-end computing system 215 can include front-end code 218 and front-end templates 219. Front-end code 218 and front-end templates 219 can be used by API(s) 214 to organize content 212 in a manner that can be rendered via a plurality of user devices (e.g., devices 220A-220E). For instance, Front-end template(s) can include a first template associated with providing display via a mobile device (e.g., device 220A), a second template associated with providing display via a virtual reality/augmented reality (VR/AR) device (e.g., device 220B), a third template associated with providing display via a web browser of a computing device (e.g., device 220C), a fourth template associated with providing display via an audio interface of a device (e.g., device 220D), or a fifth template associated with providing display via a wearable device (e.g., device 220E). Devices 220A-220E have been described as particular types of devices for illustrative purposes only and are not meant to limit the disclosure. Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

Organization users can include content providers that can interface with a network computing system associated with the headless CMS service entity to generate, modify, or provide content to be displayed (e.g., published) to end users. The headless CMS service entity can provide for an interface for content providers to interact with to generate and modify content items and can provide a computing system for facilitating serving (e.g., publishing) the content from the content provider to the end user in a format that improves user experience on both the content provider and end-user side.

Organization users can include developers that can interface with a network computing system associated with the headless CMS service entity to create applications, create integrations with IoT devices, develop applications and websites, modify applications and websites, and the like.

In some implementations, the headless CMS service entity can be associated with providing Software as a Service (SaaS) to organization users or other users. In some implementations users can include business users. The organizations can have one or more users associated with the content provider. The one or more users can have designated roles associated with permissions. The permissions can be associated with one or more keys (e.g., features) associated with the headless CMS service. For instance, keys can relate to an ability to adjust content items, add more users, perform API calls, and the like. Tokens can include access tokens, delivery tokens, management tokens, and authtokens. Tokens can be utilized to allow users with tokens to perform certain actions or access certain pages that a user without a token cannot access. For instance, tokens can be associated with the ability to rate limit, create stacks, adjust the number of users, adjust roles of users, and the like.

The present disclosure relates to the content management system entry variant storage and resolution that allow for the front-end code 218 and front-end templates 219 to provide for visual display content items.

Using the disclosed technology different variants can be requested using an API, which can be configured to return a resolved response. If variants are requested and there is a conflict, the conflict needs to be resolved in a reliable manner.

When a request is made to the delivery API for multiple variants the order of the variants in the request will determine the priority when fields are in conflict. If thinking about the variants as layers in a graphics program, the base entry is on the bottom and the first requested variant is the highest priority variant and is on top of the second, meaning if there is a conflict, the value from the first is shown.

The following provides for an example user case for A/B Testing & Personalization:
An entry has multiple variants for the same fields:
   Hero image has different entries for:
      Base entry (default audience)
      Variant A Test
      Variant B Test
      Tier 1 Membership
      Tier 2 Membership
   Call to action (CTA) for the hero image has different entries:
      Base entry (default audience)
      Variant A Test
      Tier 1 Membership
   JSON RTE
      Base entry (default audience)
      Tier 1 membership
   All other fields
      Base entry (default audience)
   When the system ask for the entry response
      Eclipse will respond with the priority of the audience
      The CDA will then create a single response for the entry.
         If the audience is a Tier 1 member set for a A/B Testing Group B they will get:
         The hero image for Variant B
         The CTA for Tier 1 membership
         JSON RTE for Tier 1 membership
         Base entry for all other fields
   If the audience is set for A/B Testing Group A they will get:
      The hero image for Variant A
      The CTA for Variant A
      Base entry for all other fields
   If it is the default audience they will get
      The base entry for all fields
   If the audience is a Tier 1 member set for a A/B Testing Group B, priority as a
      Tier 1 member they will get:
      The hero image for Tier 1 membership
      The CTA for Tier 1 membership
      JSON RTE for Tier 1 membership Base entry for all other fields

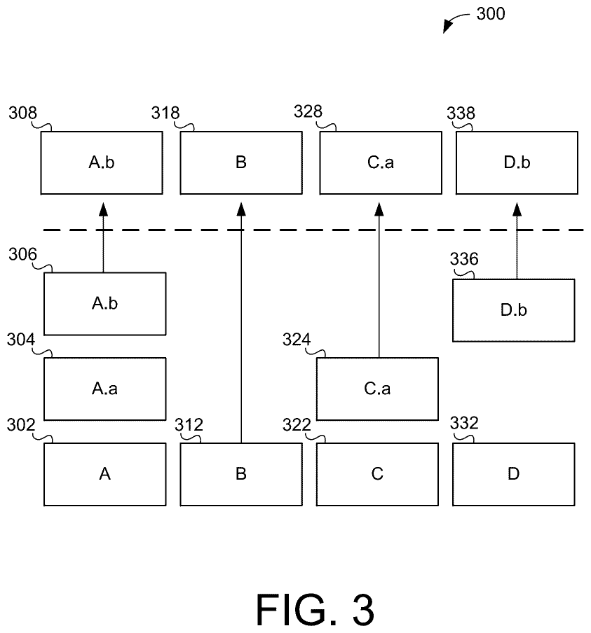

FIG. 3 depicts a block diagram of an example of the resolution of entries comprising base entries and variant entries according to example embodiments of the present disclosure. The operations described with respect to FIG. 3 can be executed and/or implemented on one or more computing devices and/or computing systems comprising, for example, the user device 110A, the user device 120A, the user device 130A, and/or the network computing system 135. The computing system 300 comprises base entry 302, entry variant 304, entry variant 306, selected entry 308, base entry 312, selected entry 318, base entry 322, entry variant 324, selected entry 328, base entry 332, entry variant 336, and selected entry 338.

The base entry 302 can be associated with entry variant 304 and entry variant 306. The entry variant 304 and/or the entry variant 306 can be combined with the base entry 302 to form a selected entry. The selected entry can be included in an API request from a client computing device (not shown) that requests content. For example, the computing system 300 can receive an API request associated with attributes that indicate content that is being requested for use by the client computing device. The computing system 300 can receive an API request comprising attributes indicating that a selected entry comprising content associated with the base entry 302 and the entry variant 306 are being requested. For example, an API request can comprise attributes associated with a free shipping interface element of a user interface of a webpage. The attributes can indicate that a free shipping option has been selected and that content associated with a variant of a webpage in which free shipping is requested has been selected. Based on the API request, the computing system 300 can send the selected entry 308, which includes the base entry 302 and the entry variant 306 to a client computing device associated with the API request. The client computing device (e.g., a laptop computing device) can then receive the base entry 302 and the entry variant 306, and generate the content associated with the base entry 302 and the entry variant 306 on a display component of the client computing device. In some embodiments, the API request can comprise information that indicates the content that is implemented on the client computing device. Based on the information indicating the content that is implemented on the client computing device (e.g., content of a webpage that is included in a web browser that is implemented on the client computing device), the computing system 300 can send, to the client computing device, variant portions of content that are not implemented on the client computing device.

The computing system 300 can receive an API request associated with attributes that indicate content being requested for use by a client computing device (not shown). The computing system 300 can receive an API request comprising attributes indicating that a selected entry comprising content associated with the base entry 312 entry is being requested. For example, an API request comprising attributes indicating that a credit card payment interface element of a user interface of a webpage has been selected and that content associated with a variant of a webpage in which information associated with payment for an order can be received has been selected. Based on the API request, the computing system 300 can send the selected entry 318, which includes the base entry 312 entry to a client computing device associated with the API request. The client computing device (e.g., a laptop computing device) can then receive the base entry 312 and generate the content associated with the base entry 312 on a display component of the client computing device.

The base entry 322 can be associated with entry variant 324. The entry variant 324 can be combined with the base entry 302 to form a selected entry. The selected entry can be included in an API request from a client computing device (not shown) that requests content. Based on the API request, the computing system 300 can send the selected entry 328, which includes the base entry 322 and the entry variant 324 to a client computing device associated with the API request. The client computing device (e.g., a smartphone) can then receive the base entry 322 and the entry variant 324, and generate the content associated with the base entry 322 and the entry variant 324 on a display component of the client computing device.

The base entry 332 can be associated with entry variant 336. The entry variant 336 can be combined with the base entry 332 to form a selected entry. The selected entry can be included in an API request from a client computing device (not shown) that requests content. Based on the API request, the computing system 300 can send the selected entry 338, which includes the base entry 332 and the entry variant 336 to a client computing device associated with the API request. The client computing device (e.g., a tablet computing device configured as a point of sale terminal) can then receive the base entry 332 and the entry variant 336, and generate the content associated with the base entry 332 and the entry variant 336 on a display component of the client computing device.

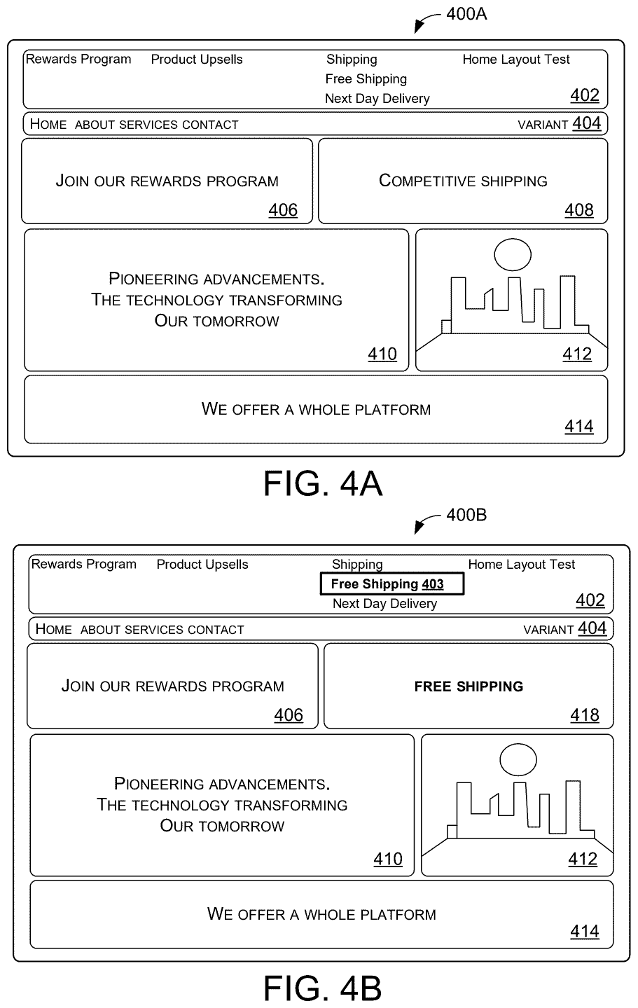

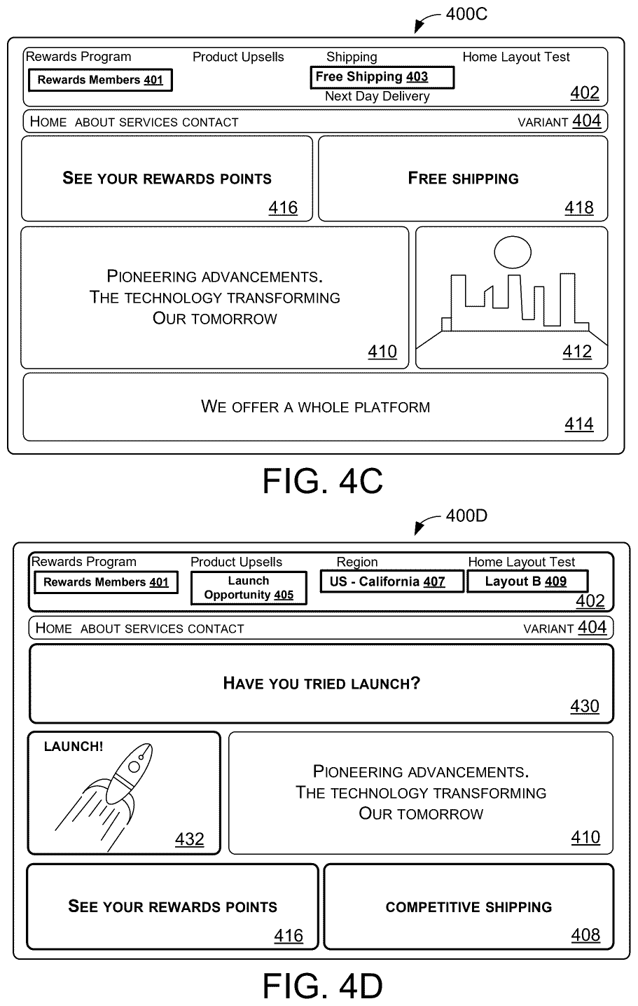

FIGS. 4A-4D depict examples of entry variants of content that are displayed via a user interface of a client device according to example embodiments of the present disclosure. The operations described with respect to FIGS. 4A-D can be executed and/or implemented on one or more computing devices and/or computing systems comprising, for example, the user device 110A, the user device 120A, the user device 130A, and/or the network computing system 135. An entry variant 400B, entry variant 400C, and the entry variant 400D can be based on a base entry 400A. The base entry 400A can be based on content associated with an ecommerce website (e.g., an ecommerce website that can be used to distribute and/or sell goods and/or services). The base entry 400A can comprise content 402-414 (e.g., interface elements associated with a user interface which can include a graphical user interface). The content of the base entry 400A can be 402-414 can comprise text and/or images. Further, the content 402 can comprise a plurality of interface elements associated with options for a “REWARDS PROGRAM,” “PRODUCT UPSELLS,” “SHIPPING,” and a “HOME LAYOUT TEST.” The content 404 can comprise a menu that includes an option (“VARIANT”) to select a variant. The content 404 can change based on one or more inputs. The content 406 comprises text that indicates “JOIN OUR REWARDS PROGRAM.”

The content 408 comprises text that indicates “COMPETITIVE SHIPPING.” The content 410 comprises text that indicates “PIONEERING ADVANCEMENTS. THE TECHNOLOGY TRANSFORMING OUR TOMORROW.” The content 412 comprises an image (e.g., an image of a city skyline). The content 414 comprises text that indicates “WE OFFER A WHOLE PLATFORM.”

The content 402-414 can be modified, removed, replaced, and/or moved based on changes in one or more attributes that can be associated with an API request. An API request that comprises attributes associated with a selected entry (e.g., a selected entry in which a free shipping option is selected) can be generated by a client computing device and sent to a computing system. The computing system can then send a base entry and/or the one or more variant portions of content that are associated with the attributes of the API request. The client computing device can then generate an entry variant of the base entry 400A based on the variant portions of content.

For example, based on an API request that comprises attributes that indicate whether to display the content 406, an entry variant that does not include the content 406 or includes different content in place of the content 406 can be generated. By way of further example, based on an API request that comprises attributes that indicate a request to modify the position (e.g., an absolute position or position relative to other content) of the content 406 within the base entry 400A, an entry variant in which the content 406 is in a different position within a layout of the base entry 400A can be generated.

The entry variant 400B can comprise a variant of the base entry 400A. In the entry variant 400B a variant portion 403 (“FREE SHIPPING”) of the content 402 can be configured to be an interface element that receives one or more inputs that can cause the client computing device that implements the entry variant 400B to generate an API request that can be sent to a computing system that, in response to receiving the API, sends one or more content variants that replace the content 408 in the base entry 400A with the content 418 (“FREE SHIPPING”) which indicates that a free shipping option has been selected.

The entry variant 400C can comprise a variant of the base entry 400A. In the entry variant 400C in addition to the variant portion 403 (“FREE SHIPPING”), a variant portion 401 (“REWARDS MEMBERS”) of the content 402 can be configured to be an interface element that receives one or more inputs that can cause the client computing device that implements the entry variant 400B to generate an API request that can be sent to a computing system. The API request can be associated with one or more attributes of the base entry 400A to modify and/or include in the entry variant 400C. In response to receiving the API, the computing system can send one or more variant portions of content that can replace the content 408 in the base entry 400A with the content 418 (“FREE SHIPPING”) which indicates that a free shipping option has been selected. Further, the computing system can send one or more variant portions of content that can replace the content 406 of the base entry 400A with the content 416 (“SEE YOUR REWARDS POINTS”). The entry variant 400D can comprise a variant of the base entry 400A. In the entry variant 400D in addition to the variant portion 401 (“REWARDS MEMBERS”), the variant portion 405 (“REWARDS MEMBERS”) of the content 402, the variant portion 407 (“US—CALIFORNIA”) of the content 402, and/or the variant portion 409 (“LAYOUT B”) of the content 402 can be configured to be an interface element that receives one or more inputs that can cause the client computing device that implements the entry variant 400B to generate an API request that can be sent to a computing system. Based on the attributes associated with the variant portion 405 of the content 402, the API request can be associated with one or more attributes of the base entry 400A to modify and/or include in the entry variant 400D. In response to receiving the API request associated with the variant portion 405, the computing system can send one or more variant portions of content including the content 430 (“HAVE YOU TRIED LAUNCH?”) and/or the content 432 (e.g., an image of a rocket ship).

Further, based on the attributes associated with the variant portion 407 of the content 402, the API request can be associated with one or more attributes of the base entry 400A to modify and/or include in the entry variant 400D. In response to receiving the API request associated with the variant portion 407, the computing system can send one or more variant portions of content including the content 432 (e.g., an image of a rocket ship). Further, based on the attributes associated with the variant portion 409 of the content 402, the API request can be used to modify a layout of the base entry 400A. For example, the content 408 and the content 416 can be positioned at the bottom portion of the entry variant 400D. Further, the content 410 can be positioned on the right side of the entry variant 400D.

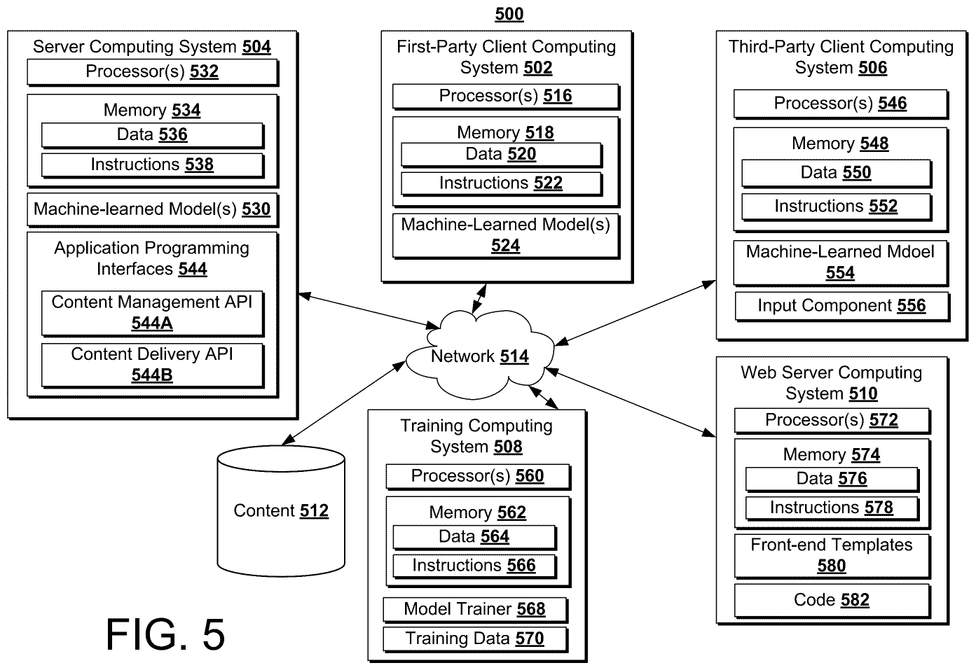

FIG. 5 depicts a block diagram of an example computing system 500 that allocates system resources using dual-limit account provisioning according to example embodiments of the present disclosure. The computing system 500 includes a first-party client computing system 502, a server computing system 504, a third-party client computing system 506, a training computing system 508, a web server computing system 510, and content database 512 that are communicatively coupled over a network 514.

The first-party client computing system 502 can include one or more computing devices. Computing devices can include any type of computing device, such as, for example, a personal computing device (e.g., laptop computing device or desktop computing device), a mobile computing device (e.g., smartphone or tablet computing device), a wearable computing device, an embedded computing device, or any other type of computing device.

The one or more devices associated with first-party client computing system 502 include one or more processors 516 and a memory 518. The one or more processors 516 can be any suitable processing device (e.g., a processor core, a microprocessor, an ASIC, an FPGA, a controller, and/or a microcontroller) and can be one processor or a plurality of processors that are operatively connected. The memory 518 can include one or more computer-readable storage media which may be non-transitory, such as RAM, ROM, EEPROM, EPROM, flash memory devices, magnetic disks, and/or combinations thereof. The memory 518 can store data 520 and instructions 522 which are executed by the processor 516 to cause the first-party client computing system 502 to perform operations.

In some implementations, the first-party client computing system 502 can store or include one or more machine-learned models 524. For example, the machine-learned models 524 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 524 can be received from the server computing system 504 over network 514, stored in the memory 518, and then used or otherwise implemented by the one or more processors 546. In some implementations, the first-party client computing system 502 can implement multiple parallel instances of a single machine-learned model.

More particularly, the machine learned model can obtain data indicative of user input. The user data can be associated with a current user session or include historical user data (e.g., historical data 150D). For example, data associated with a current user session can be data obtained in real-time via an input component.

Historical user data can include data associated with a user account, user characteristics, etc. Historical user data can include data associated with a user device (e.g., device identifier). In addition, or alternatively, historical user data can include data associated with a user identifier. In some embodiments, historical user data can include aggregate data associated with a plurality of user identifiers. In some embodiments, the training data 570 can include session data (e.g., of one or more input sessions) associated with one or more input devices, such as session data indexed over a type of input interface or device (e.g., mobile device with touchscreen, mobile device with keyboard, large touchscreen, small touchscreen, large touchscreen, voice inputs, or combinations thereof, etc.). In some embodiments, the training data 570 can include session data that is not associated with user identifiers.

Additionally, or alternatively, one or more machine-learned models 524 can be included in or otherwise stored and implemented by the server computing system 504 that communicates with the first-party client computing system 502 according to a client-server relationship. For example, the machine-learned models 524 can be implemented by the server computing system 504 as a portion of a web service (e.g., a content development service). Thus, one or more machine-learned models 524 can be stored and implemented at the first-party client computing system 502 or one or more machine-learned models 524 can be stored and implemented at the server computing system 504.

Further, the first-party client computing system 502 can include one or more user input components that can receive user input. For example, the user input component can be a touch-sensitive component (e.g., a touch-sensitive display screen or a touch pad) that is sensitive to the touch of a user input object (e.g., a finger and/or a stylus). The touch-sensitive component can serve to implement a virtual keyboard. Other example user input components include a microphone, a traditional keyboard, or other means by which a user can provide user input.

The server computing system 504 includes one or more processors 532 and a memory 534. The one or more processors 532 can include any suitable processing device (e.g., a processor core, a microprocessor, an ASIC, an FPGA, a controller, a microcontroller, etc.) and can be one processor or a plurality of processors that are operatively connected. The memory 534 can include one or more computer-readable storage media which may be non-transitory, such as RAM, ROM, EEPROM, EPROM, flash memory devices, magnetic disks, etc., and combinations thereof. The memory 534 can store data 536 and instructions 538 which are executed by the processor 532 to cause the server computing system 504 to perform operations.

In some implementations, the server computing system 504 includes or is otherwise implemented by one or more server computing devices. In instances in which the server computing system 504 includes plural server computing devices, such server computing devices can operate according to sequential computing architectures, parallel computing architectures, or some combination thereof.

The server computing system 504 can include one or more APIs. APIs can include content management API 544A, or content delivery API 544B.

Server computing system 504 can interface with the one or more user devices (e.g., user devices associated with first-party client computing system 502, third-party client computing system 506, or web server computing system 510) associated with one or more users (e.g., organization users 105, third-party users 115, or first-party users 125) using one or more application programming interfaces 544. For instance, organization user devices (e.g., user device associated with third-party client computing system 506) can interface with server computing system 504 via content management API 544A. For instance, third-party user devices (e.g., user device associated with web server computing system 510) can interface with server computing system 504 via content delivery API 544B.

As described above, the server computing system 504 can store or otherwise include one or more machine-learned models 530. For example, the one or more machine-learned models 530 can be or can otherwise include various machine-learned models.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 530 are discussed herein.

The first-party client computing system 502, third-party client computing system 506, or the server computing system 504 can train the one or more machine-learned models 524, 530, or 554 via interaction with the training computing system 508 that is communicatively coupled over the network 514. The training computing system 508 can be separate from the server computing system 504 or can be a portion of the server computing system 504.

The third-party client computing system 506 can include one or more computing devices. Computing devices can include any type of computing device, such as, for example, a personal computing device (e.g., laptop or desktop), a mobile computing device (e.g., smartphone or tablet), a wearable computing device, an embedded computing device, or any other type of computing device. Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

The one or more devices associated with third-party client computing system 506 include one or more processors 546 and a memory 548. The one or more processors 546 can be any suitable processing device (e.g., a processor core, a microprocessor, an ASIC, an FPGA, a controller, a microcontroller, etc.) and can be one processor or a plurality of processors that are operatively connected. The memory 548 can include one or more computer-readable storage media which may be non-transitory, such as RAM, ROM, EEPROM, EPROM, flash memory devices, magnetic disks, etc., and combinations thereof. The memory 548 can store data 550 and instructions 552 which are executed by the processor 546 to cause the third-party client computing system 506 to perform operations.

In some implementations, the third-party client computing system 506 can store or include one or more machine-learned models 554. For example, the machine-learned models 554 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 554 are discussed herein.

In some implementations, the one or more machine-learned models 554 can be received from the server computing system 504 over network 514, memory 548 (e.g., stored in a user computing device memory associated with third-party client computing system 506), and then used or otherwise implemented by the one or more processors 546. In some implementations, the third-party client computing system 506 can implement multiple parallel instances of a single machine-learned model 554.

More particularly, the machine learned model can obtain data indicative of user input. The user input data can be associated with a current user session or include historical user data. For example, data associated with a current user session can be data obtained in real-time via an input component 556. User data can include user session data, user context data, and user account data.

The third-party client computing system 506 can include user data. User data can include user session data, user context data, or user account data. User session data can include data obtained via input component 556 indicative of a current user session. For example, user session data can include a request for access to a particular feature, or data indicative of a utilization amount of a particular feature received within a threshold time of the current session. For example, a user can submit a first request and five minutes later submit a second request. The proximity of the first request and second request in time can be context data.

In some implementations, user data can be used as input for one or more machine-learned models 524, 530, or 554. User data can include data associated with a user account, user characteristics, and the like. User data can include data associated with a user device (e.g., device identifier). In addition, or alternatively, user data can include data associated with a user identifier. In some embodiments, user data can include aggregate data associated with a plurality of user identifiers (e.g., a group of users associated with an organization). In some embodiments, the user session data can include data indicative of one or more input sessions associated with an input component 556 of a device. In some embodiments, data in a database associated with user data can be used as training data 570.

Additionally, or alternatively, one or more machine-learned models 554 can be included in or otherwise stored and implemented by the server computing system 504 that communicates with the third-party client computing system 506 according to a client-server relationship. For example, the machine-learned models 554 can be implemented by the server computing system 504 as a portion of a web service (e.g., a content development service, a campaign management service, a content strategy management service). Thus, one or more models 554 can be stored and implemented at the third-party client computing system 506 or one or more models 554 can be stored and implemented at the server computing system 504.

The training computing system 508 includes one or more processors 560 and a memory 562. The one or more processors 560 can be any suitable processing device (e.g., a processor core, a microprocessor, an ASIC, an FPGA, a controller, a microcontroller, etc.) and can be one processor or a plurality of processors that are operatively connected. The memory 562 can include one or more computer-readable storage media which may be non-transitory, such as RAM, ROM, EEPROM, EPROM, flash memory devices, magnetic disks, etc., and combinations thereof. The memory 562 can store data 564 and instructions 566 which are executed by the processor 560 to cause the training computing system 508 to perform operations. In some implementations, the training computing system 508 includes or is otherwise implemented by one or more server computing devices associated with server computing system 504.

The training computing system 508 can include a model trainer 568 that trains the machine-learned models 524, 530, or 554 stored at the first-party client computing system 502, third-party client computing system 506, or the server computing system 504 using various training or learning techniques, such as, for example, backwards propagation of errors. For example, a loss function can be back propagated through the one or more models to update one or more parameters of the one or more models (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 568 can perform a number of generalization techniques (e.g., weight decays, dropouts, etc.) to improve the generalization capability of the models being trained.

In particular, the model trainer 568 can train the machine-learned models 524, 530, or 554 based on a set of training data 570. The training data 570 can include, for example, user feature utilization data or user session data.

In some embodiments, the machine-learned models 524, 530, or 554 can be trained using reinforcement learning. The computing system can learn appropriate weights based on receiving a reward for output that result in positive feedback. The training data 570 and user data (e.g., user session data, user context data, or user account data) can be used by a model trainer 568 to train any of machine-learned models 524, 530, or 554.

In some implementations, the computing system can train one or more machine-learned models of the machine-learned models 524, 530, or 554 through the use of one or more model trainers and training data. The one or more model trainer can train any one of the one or more models using one or more training or learning algorithms. One example training technique is backwards propagation of errors. In some implementations, the one or more model trainers can perform supervised training techniques using labeled training data. In other implementations, the one or more model trainers can perform unsupervised training techniques using unlabeled training data. In some implementations, the training data can include simulated training data (e.g., training data obtained from simulated scenarios, inputs, configurations, environments). In some implementations, the computing system can implement simulations for obtaining the training data or for implementing the one or more model trainers for training or testing the one or more models. By way of example, the one or more model trainers can train one or more components of a machine-learned model to generate recommended limits using unsupervised training techniques using an objective function (e.g., costs, rewards, heuristics, constraints, etc.). In some implementations, the one or more model trainers can perform a number of generalization techniques to improve the generalization capability of the one or more models being trained. Generalization techniques include weight decays, dropouts, or other techniques.

In some implementations, if the user has provided consent, the training examples can be provided by the third-party client computing system 506. Thus, in such implementations, the machine-learned model 554 provided to the third-party client computing system 506 can be trained by the training computing system 508 on user-specific data received from the third-party client computing system 506. In some instances, this process can be referred to as personalizing the model.

The model trainer 568 includes computer logic utilized to provide desired functionality. The model trainer 568 can be implemented in hardware, firmware, or software controlling a general-purpose processor. For example, in some implementations, the model trainer 568 includes program files stored on a storage device, loaded into a memory, and executed by one or more processors. In other implementations, the model trainer 568 includes one or more sets of computer-executable instructions that are stored in a tangible computer-readable storage medium such as RAM, hard disk, or optical or magnetic media.

The network 514 can be any type of communications network, such as a local area network (e.g., intranet), wide area network (e.g., Internet), or some combination thereof and can include any number of wired or wireless links. In general, communication over the network 514 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the machine-learned models can be deployed on-device. For example, one or more components of a predictive machine-learned model or pipeline can be deployed on-device to avoid the upload of potentially sensitive information relating to the types of input, the types of devices, or the contents of the inputs (e.g., relating to disabilities, contact information, address, etc.) to a server. For example, the server computing system can send a form with a learned context vector describing one or more input fields associated with a component (e.g., portion of an application associated with performance of a processing task). An onboard client model associated with the first-party client computing system 502 or third-party client computing system 506 can input local client characteristics (e.g., obtained via the input component 528 or input component 556) and a context vector to generate a composed modular application. This on-device processing can increase data privacy for a user. In some embodiments, this can also reduce the amount of data transmitted off-device, thereby reducing bandwidth usage.

The web server computing system 510 can include one or more computing devices. Computing devices can include any type of computing device, such as, for example, a personal computing device (e.g., laptop or desktop), a mobile computing device (e.g., smartphone or tablet), a wearable computing device, an embedded computing device, or any other type of computing device. Computing devices associated with web server computing system 510 can be third-party devices associated with end users or consumers of the content generated, managed, and published by a headless content management system (e.g., associated with server computing system 504). Devices can additionally include, but are not limited to, mobile devices, computers, laptops, AR/VR headsets, autonomous vehicles, vehicles, autonomous robots, social media applications being utilized on a device, merchant devices, IoT devices (e.g., household appliances), wearables (e.g., smart watch, smart glasses), speakers, tablets, or any other devices that can interface with a headless CMS API.

The one or more devices associated with web server computing system 510 include one or more processors 572 and a memory 574. The one or more processors 572 can be any suitable processing device (e.g., a processor core, a microprocessor, an ASIC, an FPGA, a controller, a microcontroller, etc.) and can be one processor or a plurality of processors that are operatively connected. The memory 574 can include one or more computer-readable storage media which may be non-transitory, such as RAM, ROM, EEPROM, EPROM, flash memory devices, magnetic disks, etc., and combinations thereof. The memory 574 can store data 576 and instructions 578 which are executed by the processor 572 to cause the web server computing system 510 to perform operations.

The operations can include executing one or more front-end templates 580 or code 582 to provide content items to devices associated with end users (e.g., consumers). The content items can be generated by obtaining content from content database 512 (e.g., associated with server computing system) over network 514. For instance, the front-end template 580 and code 582 can be utilized to provide for display parent windows, iFrames, or modal components to end users (e.g., via third-party client computing system 506).

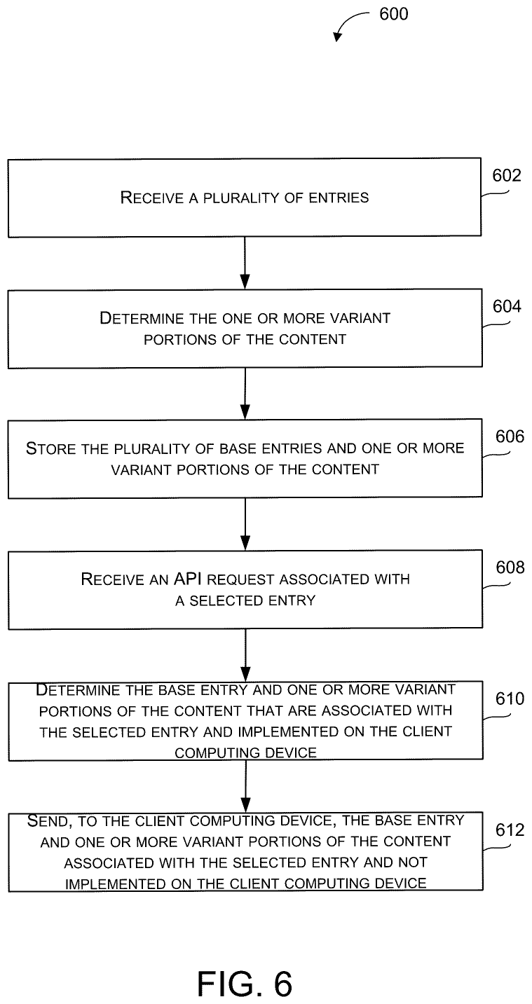

FIG. 6 depicts a flow chart diagram of an example method of processing content according to example embodiments of the present disclosure. One or more portions of the method 600 can be executed and/or implemented on one or more computing devices and/or computing systems comprising, for example, the user device 110A, the user device 120A, the user device 130A, and/or the network computing system 135. Further, one or more portions of the method 700 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include receiving a plurality of entries comprising a plurality of base entries and one or more entry variants that are variants of the plurality of base entries. The plurality of entries can comprise a plurality of portions of content associated with one or more web resources. For example, the network computing system 135 can receive data comprising a plurality of entries from a remote computing device or remote computing device that is configured to generate, process, and/or send the plurality of entries.

At 604, the method 600 can include determining one or more variant portions of the content comprising the plurality of portions of the content that are included in the one or more entry variants and the plurality of portions of the content that are not included in the plurality of base entries. For example, the network computing system 135 perform operations to process the plurality of entries and/or determine one or more variant portions of the content comprising the plurality of portions of the content that are included in the one or more entry variants and/or the plurality of portions of the content that are not included in the plurality of base entries.

At 606, the method 600 can include storing the plurality of base entries and the one or more variant portions of the content. For example, the network computing system 135 can store a plurality of entries comprising the plurality of base entries and the one or more variant portions of the content in storage devices of the network computing system 135.

At 608, the method 600 can include receiving an application programming interface (API) request associated with a selected entry of the plurality of entries. The API request can comprise one or more attributes associated with representation of the selected entry. Further, the one or more attributes can comprise information associated with the content that is implemented on a client computing device associated with the API request. For example, the network computing system 135 can receive data comprising an API request (e.g., an API request comprising attributes associated with selecting same day delivery) from the user device 110A. Further, the attributes can indicate the state of content being displayed on a web browser that is implemented on the user device 110A.

At 610, the method 600 can include determining, based on the one or more attributes, the base entry and the one or more variant portions of the content that are associated with the selected entry and implemented on the client computing device. For example, the network computing system 135 perform operations to search the plurality of entries and match the selected entry to the stored based entries and stored variant portions of content. Further, the network computing system 135 can determine that content that is currently being implemented on a web browser of a client computing device (e.g., the user device 110A).

At 612, the method 600 can include sending, to the client computing device, the base entry and the one or more variant portions of the content that are associated with the selected entry and not implemented on the client computing device. For example, the network computing system 135 can send data comprising the base variant and/or the one or more variant portions of the content associated with a selected entry (e.g., a selected entry associated with a variant of an ecommerce web page) that are not currently being implemented on the user device 110A to the user device 110A.

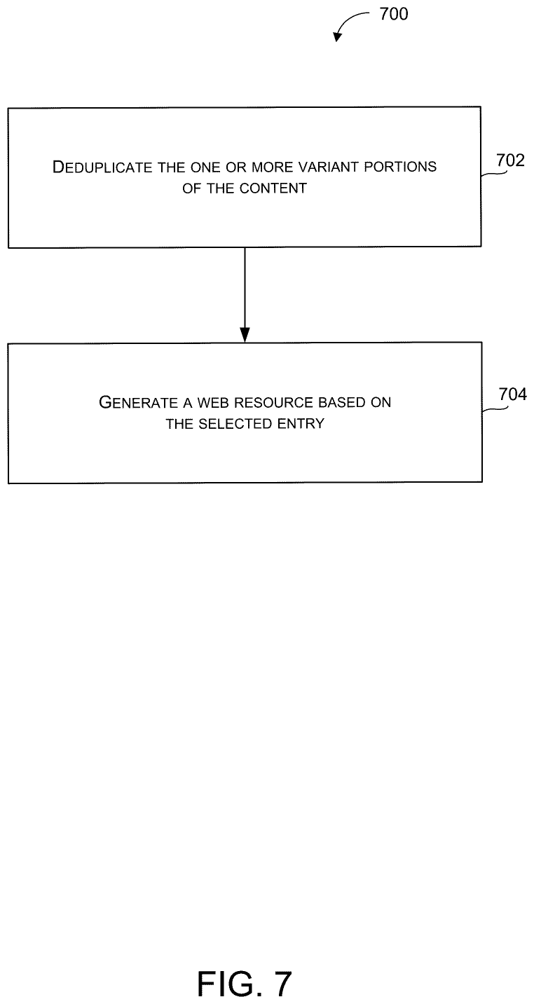

FIG. 7 depicts a flow chart diagram of an example method of processing content according to example embodiments of the present disclosure. One or more portions of the method 700 can be executed and/or implemented on one or more computing devices and/or computing systems comprising, for example, the user device 110A, the user device 120A, the user device 130A, and/or the network computing system 135. Further, one or more portions of the method 700 can be executed or implemented as an algorithm on the hardware devices or systems disclosed herein. In some embodiments, one or more portions of the method 700 can be performed as part of the method 600 that is described with respect to FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include deduplicating the one or more variant portions of the content. For example, the network computing system 135 perform operations to determine variant portions of content that are redundant and/or deduplicate the one or more variant portions that are duplicates of other variant portions that are the same.

At 704, the method 700 can include generating a web resource based on the selected entry. The web resource can comprise a web page configured to display the base entry and/or the one or more variant portions of content associated with the selected entry. For example, the network computing system 135 perform operations to generate a web resource (e.g., a web page for an ecommerce website) based on the selected entry.

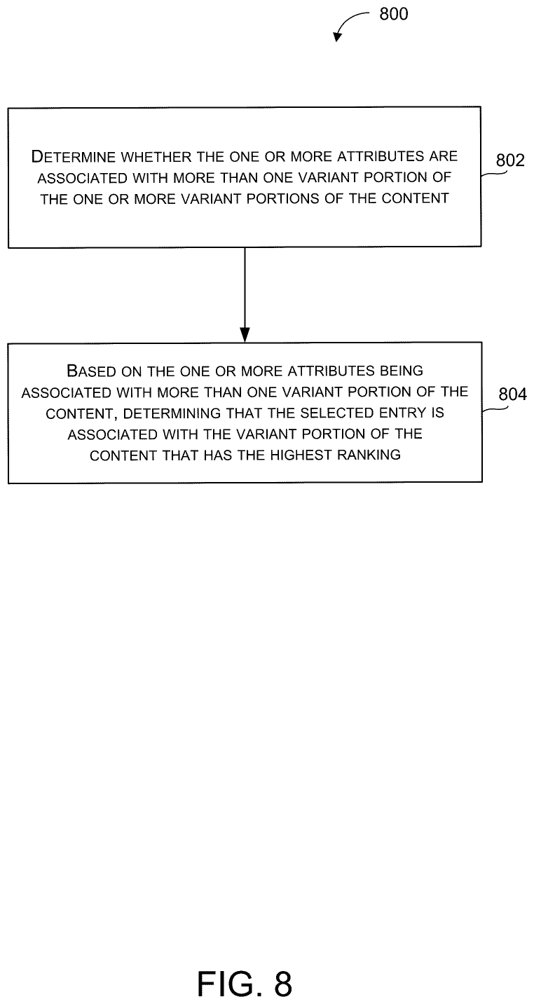

FIG. 8 depicts a flow chart diagram of an example method of processing content according to example embodiments of the present disclosure. One or more portions of the method 800 can be executed and/or implemented on one or more computing devices and/or computing systems comprising, for example, the user device 110A, the user device 120A, the user device 130A, and/or the network computing system 135. Further, one or more portions of the method 800 can be executed or implemented as an algorithm on the hardware devices or systems disclosed herein. In some embodiments, one or more portions of the method 800 can be performed as part of the method 600 that is described with respect to FIG. 6. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining whether the one or more attributes are associated with more than one variant portion of the one or more variant portions of the content. For example, the network computing system 135 perform operations (e.g., determining whether more than one variant portion is associated with the one or more attributes) to determine whether the one or more attributes are associated with more than one variant portion of the one or more variant portions of the content.

At 804, the method 800 can include determining that the selected entry is associated with the variant portion of the content that has the highest ranking. In some embodiments, associating the selected entry with the variant portion of the content that has the highest ranking can be based on and/or contingent on the one or more attributes being associated with more than one variant portion of the content. For example, the network computing system 135 perform operations to compare the one or more attributes to information associated with the rankings of the one or more variant portions and can determine that the highest ranking variant portion is associated with the selected entry and/or the base entry associated with the selected entry.

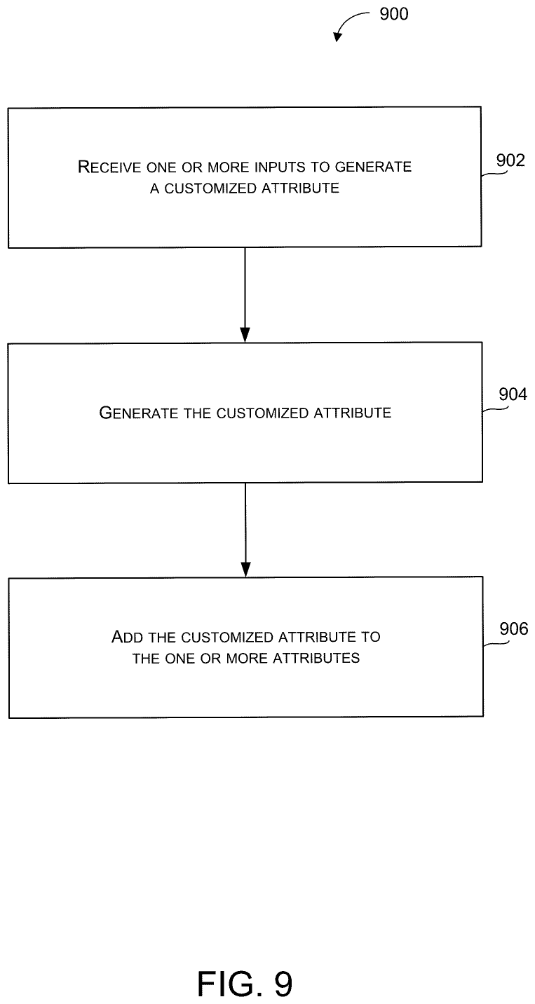

FIG. 9 depicts a flow chart diagram of an example method of processing content according to example embodiments of the present disclosure. One or more portions of the method 900 can be executed and/or implemented on one or more computing devices and/or computing systems comprising, for example, the user device 110A, the user device 120A, the user device 130A, and/or the network computing system 135. Further, one or more portions of the method 900 can be executed or implemented as an algorithm on the hardware devices or systems disclosed herein. In some embodiments, one or more portions of the method 900 can be performed as part of the method 600 that is described with respect to FIG. 6. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving, from the client computing device, one or more inputs to generate a customized attribute. For example, the network computing system 135 can receive data associated with one or more inputs to generate a customized attribute from the user device 110A.

At 904, the method 900 can include generating the customized attribute based on the one or more inputs. For example, the network computing system 135 can perform operations to generate the customized attribute based on the one or more inputs.

At 906, the method 900 can include adding the customized attribute to the one or more attributes. For example, the network computing system 135 can add the customized attribute to the one or more attributes that are stored in storage devices of the network computing system 135.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. Also, terms such as “based on” should be understood as “based at least in part on.”

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

What is claimed is:

1. A computer-implemented method comprising:
receiving, by a computing system comprising one or more processors, a plurality of entries comprising a plurality of base entries and one or more entry variants that are variants of the plurality of base entries, wherein the plurality of entries comprise a plurality of portions of content associated with one or more web resources;
determining, by the computing system, one or more variant portions of the content comprising the plurality of portions of the content that are included in the one or more entry variants and the plurality of portions of the content that are not included in the plurality of base entries;
storing, by the computing system, the plurality of base entries and the one or more variant portions of the content;
receiving, by the computing system, an application programming interface (API) request associated with a selected entry of the plurality of entries, wherein the API request comprises one or more attributes associated with representation of the selected entry, and wherein the one or more attributes comprise information associated with the content that is implemented on a client computing device associated with the API request;
determining, by the computing system, based on the one or more attributes, the base entry and the one or more variant portions of the content that are associated with the selected entry and implemented on the client computing device; and
sending, by the computing system, to the client computing device, the base entry and the one or more variant portions of the content that are associated with the selected entry and not implemented on the client computing device.

2. The computer-implemented method of claim 1, further comprising:
generating, by the computing system, a web resource based on the selected entry, wherein the web resource comprises a web page configured to display the base entry and the one or more variant portions of content associated with the selected entry.

3. The computer-implemented method of claim 1, wherein the one or more attributes comprise a language attribute associated with a language of the selected entry, a location attribute associated with a geographic location associated with the client computing device, an operating system attribute associated with an operating system implemented on the client computing device, a referrer attribute associated with a referrer associated with the API request, a device type attribute associated with a device type of the client computing device, a date attribute associated with a date associated with the API request, or a time attribute associated with a time of day associated with the API request.

4. The computer-implemented method of claim 1, wherein the plurality of entries comprise a plurality of different combinations of the plurality of portions of the content.

5. The computer-implemented method of claim 1, wherein the API request is based on one or more inputs to a user interface implemented on the client computing device, and wherein the user interface comprises a plurality of interface elements that are associated with selection of the one or more attributes.

6. The computer-implemented method of claim 1, wherein the one or more variant portions of the content are associated with a plurality of rankings ranging from a lowest ranking to a highest ranking, and wherein the determining, by the computing system, the base entry and the one or more variant portions of the content that are associated with the selected entry and implemented on the client computing device comprises:
determining, by the computing system, whether the one or more attributes are associated with more than one variant portion of the one or more variant portions of the content; and
based on the one or more attributes being associated with more than one variant portion of the content, determining, by the computing system, that the selected entry is associated with the variant portion of the content that has the highest ranking.

7. The computer-implemented method of claim 1, further comprising:
receiving, by the computing system, from the client computing device, one or more inputs to generate a customized attribute;
generating, by the computing system, the customized attribute based on the one or more inputs; and
adding, by the computing system, the customized attribute to the one or more attributes.

8. The computer-implemented method of claim 7, wherein the one or more inputs comprise an input to generate, via a user interface, the one or more attributes based on selection of one or more attribute parameters associated with the representation of the selected entry.

9. The computer-implemented method of claim 1, further comprising:
deduplicating, by the computing system, the one or more variant portions of the content.

10. The computer-implemented method of claim 1, wherein the one or more web resources comprise one or more webpages or one or more web applications.

11. The computer-implemented method of claim 1, wherein the plurality of entries comprise information associated with a plurality of layouts of the plurality of portions of the content, a plurality of color schemes of the plurality of portions of the content, or one or more sizes of the plurality of portions of the content.

12. The computer-implemented method of claim 11, wherein the plurality of layouts indicate an arrangement of the plurality of portions of the content in a web resource of the one or more web resources.

13. The computer-implemented method of claim 1, wherein the client computing device is configured to display a webpage based on the selected entry.

14. The computer-implemented method of claim 1, wherein the plurality of portions of content comprise one or more images, one or more text segments, one or more video segments, or one or more audio segments.

15. One or more tangible non-transitory computer-readable media storing computer-readable instructions that when executed by one or more processors cause the one or more processors to perform operations, the operations comprising:
receiving a plurality of entries comprising a plurality of base entries and one or more entry variants that are variants of the plurality of base entries, wherein the plurality of entries comprise a plurality of portions of content associated with one or more web resources;
determining one or more variant portions of the content comprising the plurality of portions of the content that are included in the one or more entry variants and the plurality of portions of the content that are not included in the plurality of base entries;
storing the plurality of base entries and the one or more variant portions of the content;
receiving an application programming interface (API) request associated with a selected entry of the plurality of entries, wherein the API request comprises one or more attributes associated with representation of the selected entry, and wherein the one or more attributes comprise information associated with the content that is implemented on a client computing device associated with the API request;
determining, based on the one or more attributes, the base entry and the one or more variant portions of the content that are associated with the selected entry and implemented on the client computing device; and
sending, to the client computing device, the base entry and the one or more variant portions of the content that are associated with the selected entry and not implemented on the client computing device.

16. The one or more tangible non-transitory computer-readable media of claim 15, wherein the one or more attributes comprise a language attribute associated with a language of the selected entry, a location attribute associated with a geographic location associated with the client computing device, an operating system attribute associated with an operating system implemented on the client computing device, a referrer attribute associated with a referrer associated with the API request, a device type attribute associated with a device type of the client computing device, a date attribute associated with a date associated with the API request, or a time attribute associated with a time of day associated with the API request.

17. The one or more tangible non-transitory computer-readable media of claim 15, wherein the API request is based on one or more inputs to a user interface implemented on the client computing device, and wherein the user interface comprises a plurality of interface elements that are associated with selection of the one or more attributes.

18. A computing system comprising:
one or more processors;
one or more non-transitory computer-readable media storing instructions that when executed by the one or more processors cause the one or more processors to perform operations comprising:
receiving a plurality of entries comprising a plurality of base entries and one or more entry variants that are variants of the plurality of base entries, wherein the plurality of entries comprise a plurality of portions of content associated with one or more web resources;
determining one or more variant portions of the content comprising the plurality of portions of the content that are included in the one or more entry variants and the plurality of portions of the content that are not included in the plurality of base entries;
storing the plurality of base entries and the one or more variant portions of the content;
receiving an application programming interface (API) request associated with a selected entry of the plurality of entries, wherein the API request comprises one or more attributes associated with representation of the selected entry, and wherein the one or more attributes comprise information associated with the content that is implemented on a client computing device associated with the API request;
determining, based on the one or more attributes, the base entry and the one or more variant portions of the content that are associated with the selected entry and implemented on the client computing device; and
sending, to the client computing device, the base entry and the one or more variant portions of the content that are associated with the selected entry and implemented on the client computing device.

19. The computing system of claim 18, wherein the one or more attributes comprise a language attribute associated with a language of the selected entry, a location attribute associated with a geographic location associated with the client computing device, an operating system attribute associated with an operating system implemented on the client computing device, a referrer attribute associated with a referrer associated with the API request, a device type attribute associated with a device type of the client computing device, a date attribute associated with a date associated with the API request, or a time attribute associated with a time of day associated with the API request.

20. The computing system of claim 18, wherein the API request is based on one or more inputs to a user interface implemented on the client computing device, and wherein the user interface comprises a plurality of interface elements that are associated with selection of the one or more attributes.
